(19) United States
(12) Patent Application Publication
(10) Pub. No.: US 2025/0124779 A1
(43) Pub. Date: Apr. 17, 2025

(54) Safety Alert System for Unattended Individuals in Vehicles

(71) Applicant: Paula Sbabo, Lamar, AR (US)

(72) Inventor: Paula Sbabo, Lamar, AR (US)

(21) Appl. No.: 18/641,607

(22) Filed: Apr. 22, 2024

Related U.S. Application Data
(60) Provisional application No. 63/589,333, filed on Oct. 11, 2023.

(51) Int. Cl. G08B 21/24; G08B 21/02; G08B 21/18; G08B 21/22

(52) U.S. Cl. CPC G08B 21/24; G08B 21/0205; G08B 21/182; G08B 21/22

(57) ABSTRACT

A vehicle safety alert system designed to monitor the interior of a vehicle and alert users about the presence of unattended individuals or pets, such as children or the elderly, left behind inside the vehicle is disclosed. The system includes a smart alert device which can be in a variety of portable forms including stuffed toys and is equipped with a plurality of sensors including an ignition sensor, a motion sensor, a temperature sensor, a sound sensor, and a camera to capture comprehensive visual data of the vehicle's interior. The device utilizes a processor to analyze sensor data and determine the presence of unattended individuals or pets, sending alerts to a user device through a communication network. Alerts can be audio, textual, or video messages, including real-time footage. The system includes a user-friendly application to configure alert preferences and emergency contacts, enhancing the system's utility and user convenience.

### CROSS-REFERENCE TO RELATED APPLICATION

The present application claims priority to, and the benefit of, U.S. Provisional Application No. 63/589,333, which was filed on Oct. 11, 2023 and is incorporated herein by reference in its entirety.

### FIELD OF THE INVENTION

The present invention generally relates to the field of smart alert systems. More specifically, the present invention relates to a smart alert system for a child, an elderly individual, or a pet to ensure safety in an unattended vehicle. The smart alert system comprises a smart alert device which can be paired with a user device and accordingly sends/transmits alerts to the driver, or holder of the user device, to quickly rescue the unattended child. The smart alert device/module of the present invention can be integrated into a soft toy such as a stuffed animal toy or other devices and can be available in numerous designs and configurations. A plurality of sensors are included in the device for detecting an unattended individual or pet in a locked vehicle. Accordingly, the present disclosure makes specific reference thereto. Nonetheless, it is to be appreciated that aspects of the present invention are also equally applicable to others like applications, devices, and methods of manufacture.

### BACKGROUND

By way of background, child safety is of utmost importance for parents, caregivers, and other family members. While travelling with children, despite being careful and responsible, parents or guardians may accidently leave behind the child in their car seat. There could be numerous reasons for occurrence of such incidents, for example, a driver can be busy on a call and may forget to take out the child from the car before leaving the vehicle; or the parents/guardians are sleep deprived or running late for some occasion and may forget to take the children with them; and/or the caregiver is new to the routine and may forget to take out the child from the car before locking the vehicle.

Leaving the child inside the vehicle can be dangerous, not only from the perspective of the parents but also from the perspective of the child who can become overwhelmed by the heat because of the rising temperature inside the car. Apart from that, the child can become extremely anxious when left alone inside the car. If the child is left inside the car for a long period of time, then he/she can become dehydrated and can become unconscious as well. In the U.S.A., on average 38 children under the age of 15 die every year from heatstroke and shock when left behind in vehicles.

One of the conventional methods used for child safety is setting an alarm in the mobile device of the user as the user sits in the car. The alarm can be of the estimated time of arrival to the destination. However, this could be missed by the user in situations where the user is struck in traffic or is late due to some other reasons. The user must be active and mindful to safely take out the child from the vehicle before leaving.

In the state of the art, there are some safety child seats available in the market that have sensors in the belt to detect presence of the child inside the vehicle. However, the child may take off the safety belt and the sensors may not work properly in detecting the presence of the child left behind in the car, thereby causing the users to leave behind the children in vehicles.

Therefore, there exists a long felt need in the art for a device that can alert users and inform them when a child has been left behind in a vehicle. There is also a long felt need in the art for a smart alert device that can efficiently notify users when a child is left alone inside the car even when the user reaches a destination later than expected. Additionally, there is a long felt need in the art for a smart alert system that can provide notifications to the user regarding a child left inside the vehicle even when the child takes off the safety belt. Further, there is a long felt need for a smart alert system that prevents child deaths due to heat strokes and shock when left accidently inside the vehicles. Finally, there is a long felt need in the art for a smart alert system for child safety that is efficient and ensures safety of children.

The subject matter disclosed and claimed herein, in one embodiment thereof, comprises a smart alert device in the form of a plush or soft toy for monitoring the interior of a vehicle and alerting a user about an unattended individual or pet therein. The device includes an ignition sensor configured to detect the on/off status of the vehicle's ignition system, a motion sensor for detecting movement withinside the vehicle, a temperature sensor for measuring the interior temperature of the vehicle, a sound sensor for detecting sounds withinside the vehicle, a Bluetooth module for wireless communication with the vehicle's system and a user device, a camera to provide a visual of the vehicle's interior, capable of capturing images and videos, including in motion, a transceiver for transmitting data collected by the sensors and receiving commands from the user device, and a processor configured to analyze the data from the plurality of sensors and the camera to determine the presence of an unattended individual or pet withinside the vehicle based on predefined parameter or thresholds and thresholds.

In this manner, the smart alert system and the smart alert device of the present invention accomplish all of the forgoing objectives and provide users with a safety system that monitors the interior of the vehicle to detect the presence of unattended children, elderly individuals, or pets and provides real-time alerts for safety of the unattended individual or pet. The device is designed as a stuffed toy or other unobtrusive design which makes the system less intrusive and more adaptable to different vehicle interiors. The ability to send real-time alerts, including audio, textual messages, and video footage, to a user's device provides immediate awareness of any potential danger. Moreover, the system provides capability to facilitate communication between the user and the unattended individual can help calm and reassure the individual until help arrives. The system can be adapted for various vehicle types and sizes, making the system scalable and applicable across different user demographics and vehicle models.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle safety alert system. The system further comprises a smart alert device designed to be placed within a vehicle, the smart alert device is configured as a stuffed toy. An ignition sensor is integrated in the smart alert device for detecting the ignition status of the vehicle. A camera is disposed on the smart alert device for capturing visual data of the vehicle interior. A processor is disposed within the smart alert device and is configured to process data from the sensors and the camera, and to determine the presence of an unattended individual or pet based on the processed data. The smart alert device is configured to send alerts to a user device through a communication network upon determining the presence of an unattended individual or pet, the alerts being selected from a group consisting of audio messages, textual messages, and video footage of the unattended individual or pet.

In another aspect, a smart alert device for monitoring the interior of a vehicle and alerting a user about an unattended individual or pet therein is disclosed. The device includes an ignition sensor configured to detect the on/off status of the vehicle's ignition system, a motion sensor for detecting movement withinside the vehicle, a temperature sensor for measuring the interior temperature of the vehicle, a sound sensor for detecting sounds withinside the vehicle, a Bluetooth module for wireless communication with the vehicle's system and a user device, a camera to provide a visual of the vehicle's interior, capable of capturing images and videos, including in motion, a transceiver for transmitting data collected by the sensors and receiving commands from the user device, and a processor is configured to analyze the data from the plurality of sensors and the camera to determine the presence of an unattended individual or pet withinside the vehicle based on predefined parameter or thresholds and thresholds.

In yet another embodiment, the smart alert device is configured to pair with the vehicle and the user device through the Bluetooth module, and upon determination of an unattended individual's or pet's presence by the processor, the device sends/transmits an alert to the user device via the communication network, the alert being in forms including but not limited to audio messages, textual messages, and real-time video footage of the unattended individual and pet.

In a further embodiment, a method for alerting a remote user about an unattended child, elderly individual, or pet in a vehicle is described. The method includes the steps of detecting, by a smart alert device placed withinside the vehicle, the ignition status of the vehicle using an ignition sensor, activating, by the smart alert device, sensors to collect data indicative of the presence of an unattended individual or pet withinside the vehicle when the ignition status indicates the vehicle is off, processing, by a processor within the smart alert device, the collected data to determine the presence of the unattended individual or pet, generating, by the smart alert device, an alert based on the determination that an unattended individual or pet is present withinside the vehicle, and sending, by the smart alert device through a communication network, the generated alert to a user device, the alert informing the user about the presence of the unattended individual or pet withinside the vehicle.

In another aspect, a method for enhancing the safety of unattended individuals or pets in a vehicle utilizing real-time interactive communication is described. The method includes the steps of detecting, by a smart alert device configured as a plush toy placed withinside the vehicle, the vehicle's ignition status being turned off, activating, upon detection of the ignition status, integrated sensors within the smart alert device to monitor the interior environment of the vehicle and detect the presence of an unattended individual or pet therein, capturing, by a camera integrated into the plush toy's design, real-time visual data of the unattended individual or pet, analyzing, by a processor within the smart alert device, the data collected by the sensors and the camera to confirm the presence of the unattended individual or pet, transmitting, via a communication network, an alert signal to a user device, enabling the user to visually and audibly ascertain the condition of the unattended individual or pet, and initiating, by the user through the user device, an interactive communication session with the unattended individual via the smart alert device, the session enabling the user to send real-time audio messages to and receive audio responses from the unattended individual through the smart alert device's speaker and sound sensor.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an architecture for the smart alert system of the present invention for safety of unattended child/elderly in a vehicle in accordance with one embodiment of the present invention;

FIG. 2 illustrates an exemplary smart alert device kit and the components thereof used for alerting a vehicle driver when a child is left behind in a vehicle in accordance with one embodiment of the present invention;

FIG. 3 illustrates a block diagram of the components of the smart alert device of the present invention for detecting the presence of an unattended child in locked vehicle in accordance with the disclosed architecture;

FIG. 4 illustrates a perspective view showing the smart alert device detecting the presence of an unattended child in the locked vehicle in accordance with the disclosed architecture;

FIG. 5 illustrates a perspective view showing real-time streaming of the audio/video of an unattended child while receiving alerts on the remote device in accordance with the disclosed architecture;

FIG. 6 illustrates a perspective view showing wireless connection of the safety device with the vehicle in accordance with one embodiment of the present invention;

FIG. 7 illustrates a flowchart depicting steps for setting up the software application of the system in accordance with the disclosed architecture;

FIG. 8 illustrates a flow diagram depicting a process for transmitting alerts from the smart alert device to the remote device in accordance with the disclosed architecture; and

FIG. 9 illustrates a flowchart depicting a process of transmitting real-time audio and video by the safety alert device to the remote device in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It can be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments can be combined.

As noted above, there is a long felt need in the art for a device that can alert users and inform them when a child has been left behind in a vehicle. There is also a long felt need in the art for a smart alert device that can efficiently notify users when a child is left alone inside the car even when the user reaches a destination later than expected. Additionally, there is a long felt need in the art for a smart alert system that can provide notifications to the user regarding a child left inside the vehicle even when the child takes off the safety belt. Further, there is a long felt need for a smart alert system that prevents child deaths due to heat strokes and shock when left accidently inside the vehicle. Finally, there is a long felt need in the art for a smart alert system for child safety that is efficient and ensures safety of children.

The present invention, in one exemplary embodiment, is a method for alerting a remote user about an unattended child, elderly individual, or pet in a vehicle. The method includes the steps of detecting, by a smart alert device placed withinside the vehicle, the ignition status of the vehicle using an ignition sensor, activating, by the smart alert device, sensors to collect data indicative of the presence of an unattended individual or pet withinside the vehicle when the ignition status indicates the vehicle is off, processing, by a processor within the smart alert device, the collected data to determine the presence of the unattended individual or pet, generating, by the smart alert device, an alert based on the determination that an unattended individual or pet is present withinside the vehicle, and sending, by the smart alert device, the generated alert to a user device, the alert informing the user about the presence of the unattended individual or pet withinside the vehicle.

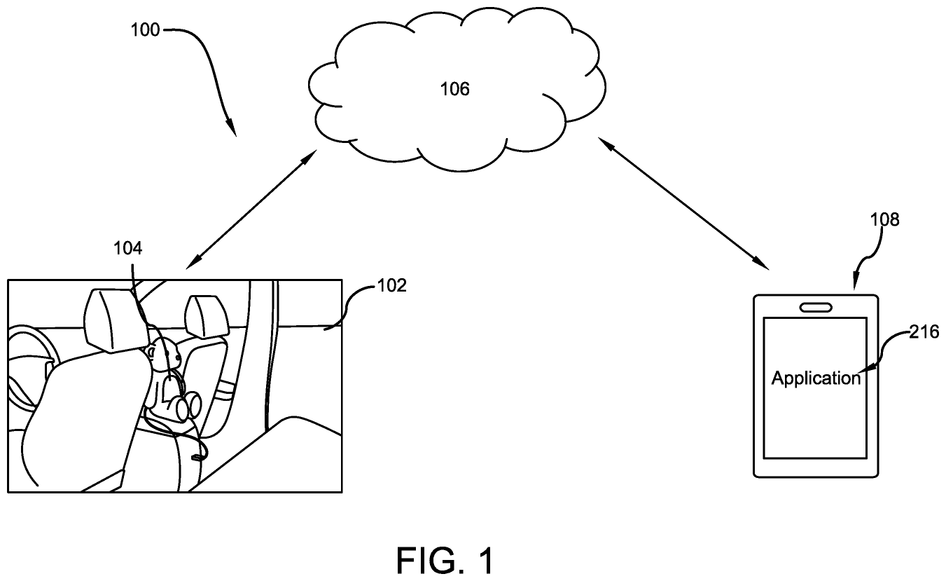

Referring initially to the drawings, FIG. 1 illustrates an architecture for the smart alert system of the present invention for safety of unattended child/elderly in a vehicle in accordance with one embodiment of the present invention. The smart alert system 100 includes communication between a smart alert device 104 preferably placed inside a vehicle 102 and a user device 108 via a communication network 106. The smart alert device 104 is preferably in the form of a portable housing or stuffed toy such as a teddy bear or can be available in numerous designs and configurations. The device 104 is paired with the vehicle 102 and its electronic control unit (ECU) to detect the ignition of the vehicle 102 and check if any baby/elderly is left unattended inside the vehicle, and further provides an alert to the user to timely rescue the unattended child or individual or pet.

In the preferred embodiment, the smart alert device 104 is integrated in a teddy bear. However, the design of the baby alert device 104 is not limited and it can be fitted in any other stuffed toy or can be available in other housing designs as per the requirements of the users. The safety alert device 104 is usually placed at a position such that a baby or elderly sitting at back or rear seat of the vehicle 102 is easily visible in the camera of the device 104 and is within the range of the Bluetooth network of the vehicle. As an example, in the present embodiment, the safety alert device 104 is placed between a space between the driver and co-driver seats of the vehicle while facing towards the back or rear seat of the vehicle, such that any passengers being seated in the backseat are easily visible in the device 104.

The smart alert device 104 can send alerts or notifications to the user device 108 via any communication network 106 and can simultaneously communicate with the sensors and electronic control unit (ECU) of the vehicle 102. The user device 108 can be a mobile device, tablet or other similar devices that is generally carried by the vehicle owner or child's parents while leaving the vehicle. The user can be parents, guardians, grandparents or any relative of the child left behind in the locked vehicle. Further, the user can be a driver of the vehicle in which the child is left behind.

The alerts or notifications sent to the user device 108 can be audio/textual messages, SMS, pop-up notification or any other kinds of alerts. Further, the notifications can be received in a baby safety alert software application 216 installed on the remote user device 108. The alerts in audio/textual format can be a warning message to the users that the child has been left behind inside the vehicle. Further, the alerts in the form of video format/message may comprise an image/video of the child present inside the vehicle. In one exemplary embodiment, the alerts can be in the form of a real-time video of the unattended child that can be sent to the user of the vehicle until he/she returns back to the vehicle. The user can also communicate with the child by sending voice messages to pacify the child while the user approaches the vehicle.

The communication network 106 used for communicating between smart alert device 104 and the user device 108 can be any of the following networks, such as a cellular connection, satellite service, wireless local area network connection, eto. In one embodiment of the present invention, the network 106 can be a cloud-based network.

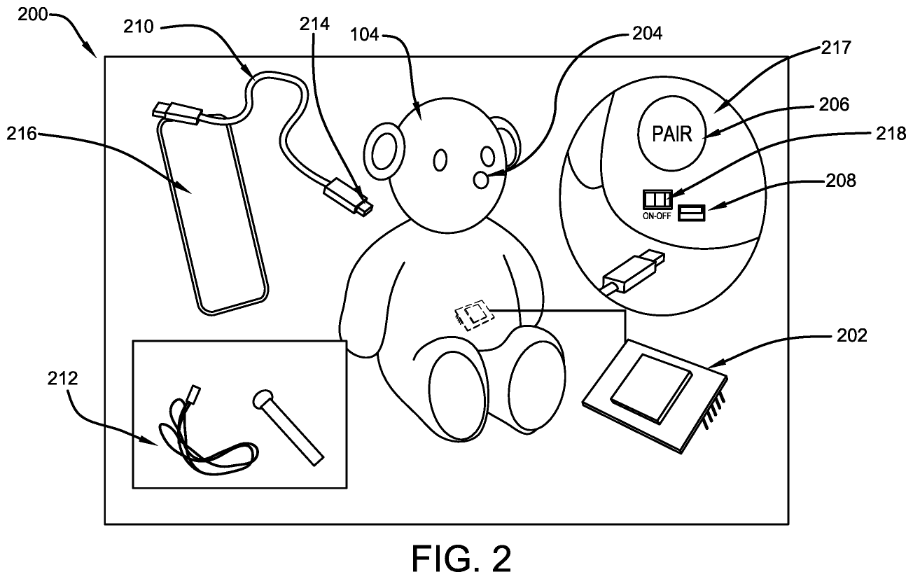

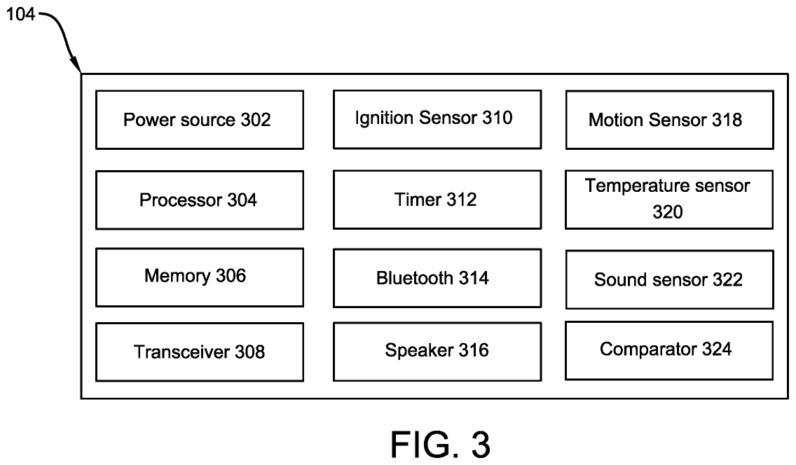

FIG. 2 illustrates an exemplary smart alert device kit and the components thereof used for alerting a vehicle driver when a child is left behind in a vehicle in accordance with one embodiment of the present invention. As shown, the smart alert device kit 200 comprises a smart alert module 202 having different sensors, chipsets, and components (shown in FIG. 3) disposed in the device 104. The device 104 includes a camera 204, a pairing button 206, a USB port 208, and a power button 218. The kit 200 further includes a charging cable 210, wires 212, and the software application 216. The software application 216 is installed in the user device 108 as illustrated in FIG. 1.

The smart alert module 202 is integrated with the device 104 and is used to detect the presence of any unattended child inside the vehicle and send alerts to a remote device handled by the vehicle owner. The camera 204 can be integrated in the device 104 in a manner such that the child is easily visible and can be recorded for alert purposes. In an exemplary embodiment, the camera 204 is disposed on the nose of the teddy bear 104, and the camera 204 is directed towards the backseat of the vehicle. In another embodiment, the camera 204 can be installed on the midsection of the teddy bear toy to obtain a clearer view of the child. The camera 204 is adapted to capture a child even when the child is in motion across the back or rear seat of the vehicle. Generally, the camera 204 can be a rotating camera or a 360-degrees camera to capture wide-angle images and monitor larger areas of the vehicle.

In one embodiment, a plurality of cameras can be installed to obtain a better view of the child within a vehicle. Design, configuration and type of camera is not limited and can be any other camera supporting wireless communication technologies to communicate with alert module 202 and send videos/images to the remote user device. The Bluetooth pairing button 206 can be a push-button, a switoh, a touch-sensitive button or other kind of button that enables a user to turn ON the Bluetooth mode of the device 104 to pair the device 104 with the vehicle's Bluetooth system and other sensors placed inside the vehicle. The pairing button 206 can also be used to pair the device 104 with another vehicle. The Bluetooth button 206 can also be used to pair the device 104 with the corresponding software application while configuring the application. The button 206 can be pushed for a first time period such as 5 seconds to pair with the vehicle and can be pushed for a second time period which is different from the first time period for pairing with the user device 108.

The USB port 208 can be used to plug in the connector 214 of the charging cable 210 and connect with device 104 with the vehicle to charge the battery of the device 104. Additional wires 212 are provided in the kit 200 that can be used make a wired connection between the device 104 and a vehicle and can be used for making the device 104 compatible with any kind of vehicle.

The software application 216 can have a unique key (provided with the kit 200) to unlock the application while configuring the application 216 for usage. The application 216 can be installed on the user's device 108 to manage the smart alert device 104 and get alerts from the device 104 in case any child or elderly has been left unattended in the locked vehicle. The application 216 is designed in a manner to provide maximum user convenience and give prompt notifications to the remote users. In an embodiment, the user may receive an alert on the software application 216 installed on the remote device 108 to watch activity of the child or may use the application 216 to STOP the alert in case the user has returned and is near the vehicle.

The power button 218 can be provided at any position on the smart alert device 104, for example, in this embodiment, the power button 218 is located on the back surface 217 of the alert device 104 and can be used to turn ON/OFF the device 104, when the device 104 is not in use. The type of power button 218 is not limited and can be any type of button to support similar functionality.

FIG. 3 illustrates a block diagram of the components of the smart alert device of the present invention for detecting the presence of an unattended child in locked vehicle in accordance with the disclosed architecture. As illustrated, the device 104 includes a power source 302, a processor 304, a memory 306, a transceiver 308, an ignition sensor 310, a timer 312, a Bluetooth module 314, a speaker 316, a motion sensor 318, a temperature sensor 320, a sound sensor 322, and a comparator 324.

The power source 302 can be any rechargeable battery (such as alkaline battery), Lithium battery, or other power supplying sources as well, that supplies power to activate the smart alert device 104 to monitor any unattended child/elderly inside the vehicle and provide alerts regarding their rescue. The power source 302 can be charged by connecting the alert device 104 to the vehicle 102 using USB charging cable 210 whenever the vehicle 102 is in an active state with ignition ON.

When the device 104 is in ACTIVE MODE (I.E., ACTUATED) (using the power button 218), different sensors such as ignition sensor 310, motion sensor 318, temperature sensor 320, and the sound sensor 322 start collecting data and store the data in real-time in the memory 306. The collected data is further transmitted to processor 304 for processing the collected data and determining the presence of unattended child/elderly in the locked vehicle 102. Accordingly, the processor 304 sends/transmits an alert to the vehicle owner to timely rescue the unattended child/elderly from the vehicle 102. The memory 306 can also store one or more computer readable instructions which when executed by the processor 304 performs the operations of the smart alert device 104.

The ignition sensor 310 is adapted to detect if the vehicle 102 is ON/OFF. Once the sensor 310 detects that the vehicle 102 is OFF, then the motion sensor 318, temperature sensor 320 and sound sensor 320 start collecting data from the vehicle 102 to respectively determine any movements, vehicle's interior temperature and any sound inside the vehicle 102 to ensure the presence of any child/elderly inside locked vehicle 102 and provide alerts to the vehicle owner. It will be noted that the device 104 may not detect the interior space of the vehicle 102 when the ignition of the vehicle is ON. In one exemplary embodiment, the ignition sensor 310 enables the ignition to be OFF for a predetermined period of time, for example 30 seconds, before initiation of collection data to allow for short engine interruptions at stops during travel of the vehicle.

In situations where the motion sensor 318 detects a child's presence for a predetermined time using timer 312 (for example 2 minutes) after the vehicle 102 is OFF (as detected by ignition sensor 310), then the processor 304 can be signaled to generate an alert. The sensors can be coupled to the timer 312 wherein the timer 312 can be preconfigured with a threshold timer value.

Various parameter or thresholds monitored by smart alert device 104 can be compared against a corresponding pre-set parameter or threshold value using the comparator 324. As an example, temperature alert can be pre-set to be more than 45° C. and when the collected temperature values are found to be 45° C. or more, then the processor 304 is signaled to communicate with other sensors such as the motion sensor 318 and others to determine presence of any child and to send alerts to the parents/guardians of the child. The pre-determined sensor values (such as temperature alert value) can be stored in the memory 306 or any other storage options integrated in the smart alert device 104.

The rise in temperature can be caused by greenhouse effect due to radiation imbalance and poor ventilation of the vehicle. Also, when the vehicle is parked in the sun, the temperature levels of the vehicle can rise quickly that may cause heat strokes or hyperthermia to any unattended child/elderly left inside the vehicle 102. All the sensors on the device 104 and inside the vehicle 102 can be coupled to the timer 312 and the comparator 324 to decide the alert factors in an efficient manner.

Different elements inside the smart alert device 104 such as the sensors ignition sensor 310, timer 312, Bluetooth module 314, motion sensor 318, temperature sensor 320, sound sensor 322, and comparator 324 can be integrated on the chipset module 202. Further, the smart alert device 104 is connected to the vehicle 102 using Bluetooth 314 or any other wireless communication technology that enables easy communication between the device 104 and vehicle 102 while enabling transmission of data between them. The transceiver 308 transmits and receives sensor signals between the smart alert device 104 and remote device 108. The data captured by the different sensors present in the device 104 can be transmitted to the remote device 108 via the transceiver 308 and similarly, any communication by the user from the remote device 108 can be received by the transceiver 308.

The speaker 316 on the device 104 is used to play pre-recorded voice messages or enables the vehicle owner to talk to the unattended child in real-time while reaching the vehicle 102. The speaker 316 enables the user to assure the child/elderly to not to be anxious and boost their mood while being locked inside the vehicle 102. Additionally, the speaker 316 can be used to initiate an alarm inside the vehicle 102 that can alert nearby individuals about the presence of the child left behind in the locked vehicle and they can take precautionary measures to rescue the child/elderly locked inside the locked vehicle 102. For example, a user may miss initial alerts on the remote device 108, and the child can be trapped for a long time period inside the vehicle, then the alarm generated using speaker 316 can alert nearby individuals to rescue the child/elderly trapped in the locked vehicle. In a preferred embodiment, the speaker 316 may alert when the temperature inside the vehicle is more than the preset threshold and the time lapsed in detecting motion by the motion sensor 318 is more than the corresponding threshold.

The sound sensor 322 senses any audio withinside the vehicle 102 and sends/transmits the determined data to the memory 306 and/or processor 304. The sound sensor 322 can detect a child crying or screaming due to anxiety or may find a child babbling when left inside the car 102. The sound sensor 322 can send the data to memory 306 to record it and share the audio with the remote user on the software application installed on his/her the user device 108.

In another embodiment, the sound sensors 322 may work simultaneously with the camera 204 to share real-time update of the unattended child with the remote user. For example, if a user mistakenly leaves a child behind in the car, the user can use the software application 216 to communicate with the child. In one embodiment, the sound sensors 322 and the camera 204 can be coupled with the timer 312 and the comparator 324 to ensure that the user obtains audio/video call within a pre-determined period since some motion has been detected.

In another embodiment of the present invention, the vehicle 102 can be integrated with door sensor (not shown) to determine if a child is trying to open the locked door when the car is in OFF state. The door sensor (not shown) can be coupled with the alert device 104 to send alert(s) to the vehicle owner to rescue the child left behind in the car 102.

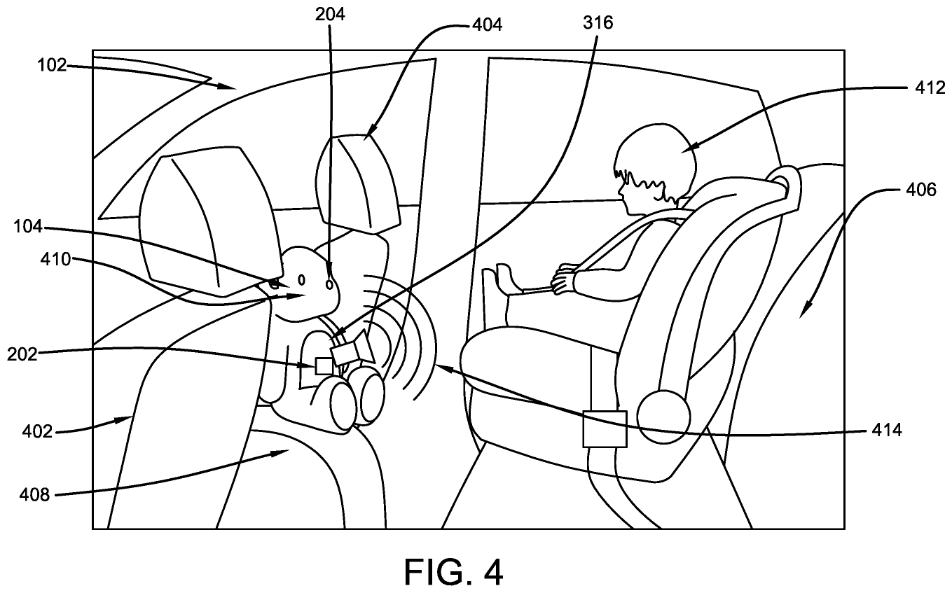

FIG. 4 illustrates a perspective view showing the smart alert device 104 detecting the presence of an unattended child in the locked vehicle in accordance with the disclosed architecture. As shown, the alert module 202 is integrated into the device 104 (in a teddy bear shaped stuffed toy) and the device 104 is preferably placed proximal to a seating area 408 between the driver seat 402 and the co-driver seat 404. The camera 204 is attached/placed over the nose 410 of the toy in a manner such that the passengers seated at the backseat 406 are easily visible. The smart alert device 104 is activated whenever the ignition of the vehicle 102 is deactivated, or after a predetermined period of time after ignition 102 is deactivated. The motion sensor (integrated on the alert module 202) detects motion in the locked and OFF state vehicle for a predetermined period. Similarly, the temperature sensor (integrated on the alert module 202) may sense when there is a rise in temperature as per pre-determined range. The software application 216 can receive an alert that there is a child 412 left behind in the car 102 before an emergency situation arises and ensures the unattended child 412 is timely rescued. As shown in FIG. 4, the voice messages 414 can be delivered through the speaker 316 on the device 104 and an alarm can also be generated using the speaker 316 to alert the nearby individuals to rescue the child 412 inside the vehicle 102.

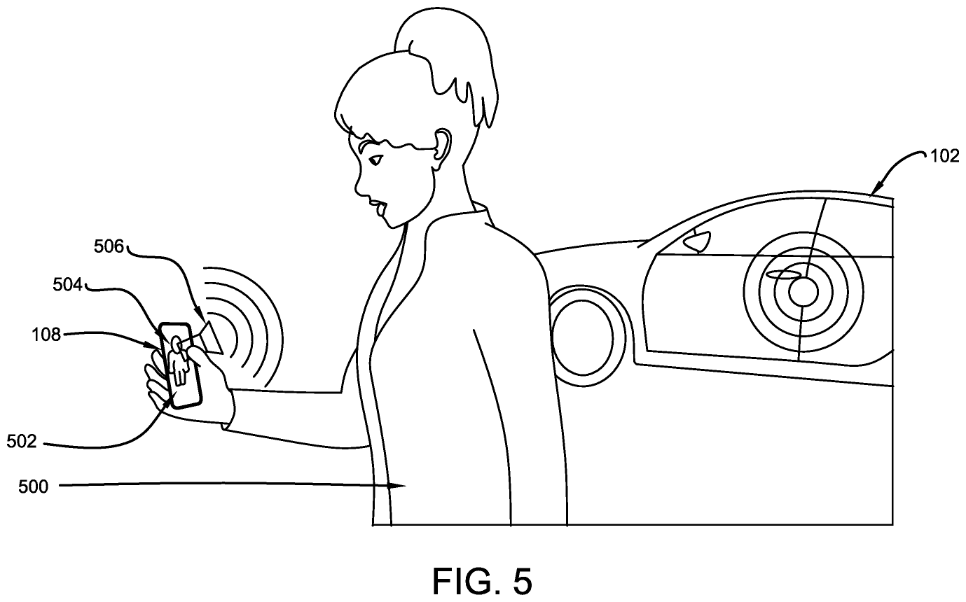

FIG. 5 illustrates a perspective view showing real-time streaming of the audio/video of an unattended child while receiving alerts on the remote device in accordance with the disclosed architecture. When an alert event occurs (as described earlier in the disclosure), the software application 216 receives and displays on an interface 502, the real-time image/video 504 and audio 506 of the child left inside the vehicle 102 in which the paired device 104 is placed. The software application 216 is initially installed and configured on the user device 108 such as mobile device of the user 500, and then different settings can be done by the user 500 while configuring the application. Accordingly, while the user 500 is away and not inside the vehicle 102, the user 500 can receive alerts and notifications as per his/her configuration settings. The alerts can be textual, audio, and/or video alerts informing the user about the change in temperature of the vehicle, motion of the child, and/or sound of the child. Using the interface of software application, the user 500 obtains access to view images/videos or hear voice of baby inside the car 102, while reaching the car destination to rescue the baby. The application 216 also enables the user 500 to make a video/audio call to the child locked inside the vehicle 102 while being at a distant location. The user 500 may communicate with the child using the mobile application to pacify the child until the user 500 returns to the car 102. The child may feel safe as well as aware that the user 500 will be back in sometime and there is no need to panic.

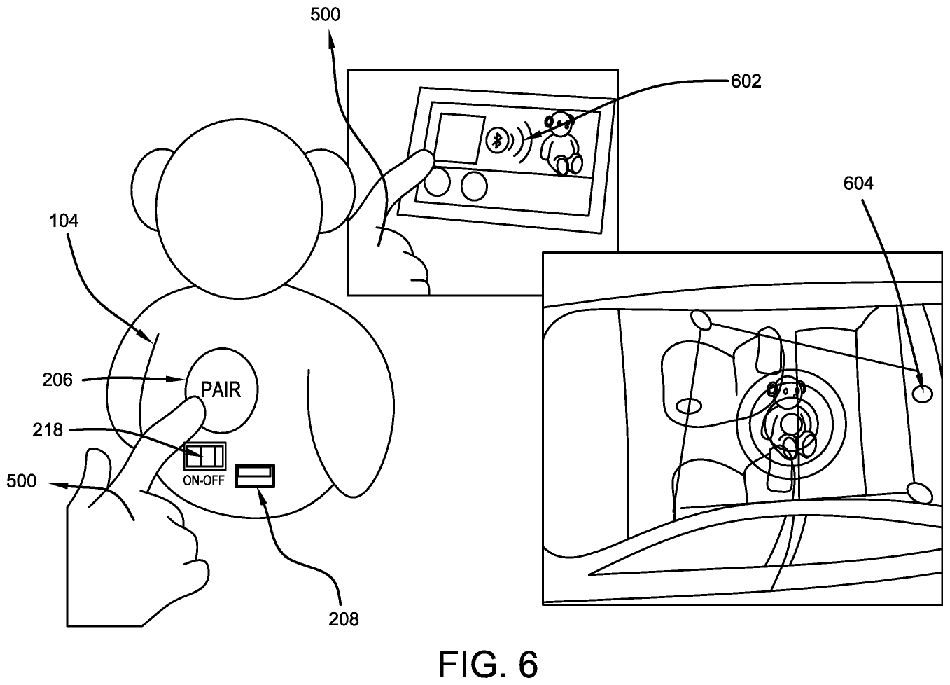

Referring now to FIG. 6, the smart alert device 104 is wirelessly connected to the vehicle 102 via the Bluetooth sensor 314. The pairing of the device 104 with the vehicle 102 enables a user to view the different parameter or thresholds configuration on the display screen 602 of the vehicle 102. Further, the child safety alert system 100 may use different vehicular sensors such as a seat belt sensor and a weight sensor to detect if a child is left behind in a locked vehicle. When the device 104 is coupled with the vehicle 102, different cameras 604 of the vehicle 102 can provide 360 degrees view of the interior of the vehicle which can be displayed on the application 216. In some embodiments, the device 104 can be in the form of an integrated sensor inside the vehicle 102 and can be coupled to the other sensors of the vehicle.

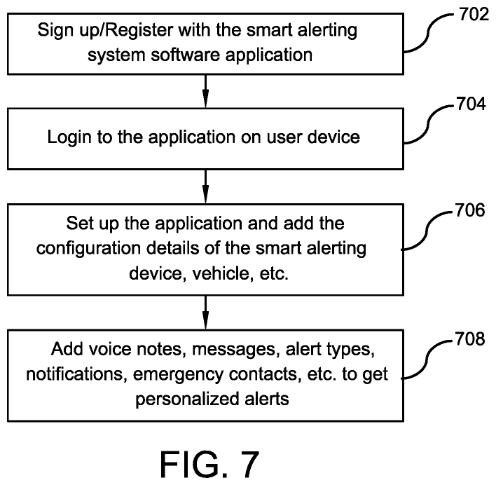

FIG. 7 illustrates a flowchart depicting steps for setting up the software application 102 of the safety alert system 100 in accordance with the disclosed architecture. At step 702, a user signs up on the smart alert system software application 216. The sign-up information may request a valid email id, contact number, user name, and more. At step 704, the method comprises logging a user into the application on the user device using the sign up information. At step 706, the user sets up the application 216 by adding the configuration details of the smart alert device and threshold of different sensors. At step 708, the method comprises, adding voice notes (including name of the child), messages, alert types, notifications, emergency contacts, and more to obtain personalized alerts. The software application may add various types of alerts such as textual, audio, and/or video alerts informing the user about the change in temperature of the vehicle, motion of the child, and/or audio of the child. The alerts can be personalized as per user's convenience. Emergency contacts can be required to touch base in case a user is not able to respond in time. The alerts can be sent to emergency contacts as well.

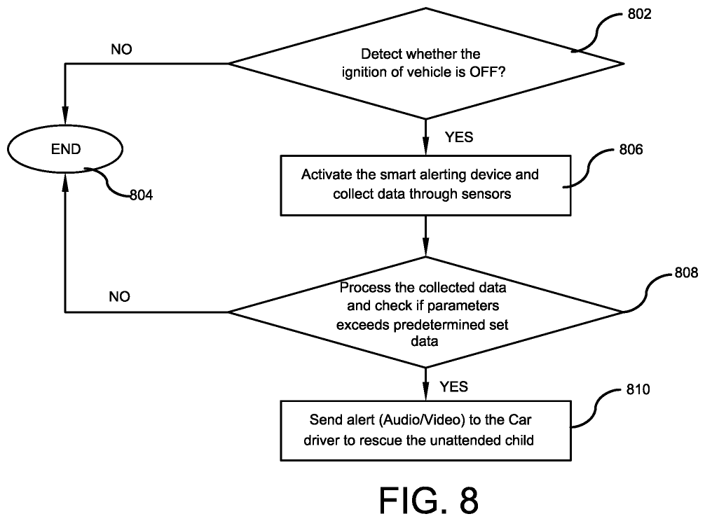

FIG. 8 illustrates a flow diagram depicting a process for transmitting alerts from the smart alert device 104 to the remote device 108 in accordance with the disclosed architecture. At step 802, the ignition status of the vehicle is determined using the ignition sensor. If the ignition is ON, then the system 100 does not perform any processing (Step 804) and the sensors of the smart alert device 104 are not activated. If the ignition is determined to be deactivated, then the method proceeds to the step 806, where the safety alert device 104 is activated and real-time data of vehicle's interior is captured through integrated sensors.

At step 808, the collected data is compared with the predetermined set of data (i.e., threshold) of each sensor. In situations where the collected data is above the corresponding threshold, the method proceeds to step 810, where the device 104 sends/transmits an alert to the application 216 to help rescue the unattended child.

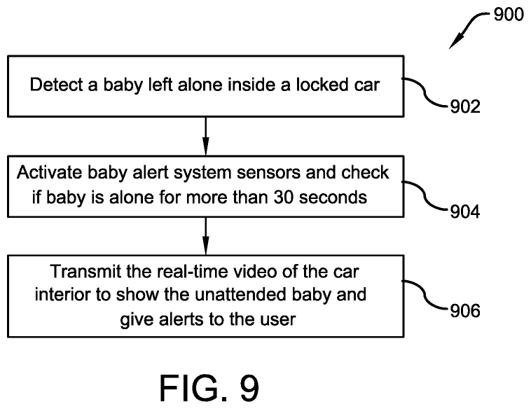

FIG. 9 illustrates a flowchart depicting a process of transmitting real-time audio and video by the safety alert device 104 to the remote device 108 in accordance with the disclosed structure. At step 902, the device 104 detects that a child left alone inside a locked car. The smart alerting device 104 is activated whenever the ignition of the vehicle 102 is deactivated.

At step 904, a time duration greater than a threshold such as 30 seconds is detected by the device 104 and the motion, temperature, and/or audio sensors may check for presence of a child inside the vehicle 102. At step 906, the device 104 transmits the real-time video of the car interior to show the unattended child and give alerts to the user.

The various actions, acts, blocks, steps, or the like in the flow diagram can be performed in the order presented, in a different order, or simultaneously. Further, in some embodiments, some of the actions, acts, blocks, steps, or the like can be omitted, added, modified, skipped, or the like without departing from the scope of the invention.

Although particular embodiments of the invention have been described in detail for purposes of illustration, various modifications and enhancements can be made without departing from the spirit and scope of the invention.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “safety alert system”, “child safety alert system”, “smart alert system”, and “system” are interchangeable and refer to the child safety alert system 100 of the present invention. Similarly, as used herein, “safety alert device”, “child safety alert device”, “smart alert device”, and “device” are interchangeable and refer to the child safety alert device 104 of the present invention.

Notwithstanding the forgoing, the child safety alert system 100 and the child safety alert device 104 of the present invention can be of any suitable size and configuration as is known in the art without affecting the overall concept of the invention, provided that they accomplish the above stated objectives. One of ordinary skill in the art will appreciate that the child safety alert system 100 and the child safety alert device 104 as shown in the FIGS. are for illustrative purposes only, and that many other sizes and shapes of the child safety alert system 100 and the child safety alert device 104 are well within the scope of the present disclosure. Although the dimensions of the child safety alert system 100 and the child safety alert device 104 are important design parameter or thresholds for user convenience, the child safety alert system 100 and the child safety alert device 104 can be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An alert system for detecting unattended individuals or pets inside a vehicle, the alert system comprising:
an alert device;
a user device; and
a communication network;
wherein said alert device having a portable housing for placement inside a vehicle;
wherein said alert device having a power source, a processor, a transceiver, an ignition sensor, a timer, a camera, a motion sensor, a temperature sensor, a sound sensor, and a comparator for collected data;
wherein said ignition sensor paired with a vehicle's electronic control unit for detecting status of an ignition system;
wherein said user device paired with said alert device with said communication network;
wherein a placement of said alert device including a position having a view of a rear seat of the vehicle to monitor an unattended individual or pet inside the vehicle;
wherein said user device is a mobile device carried by a user;
wherein said alert device transmits said collected data to said user device;
wherein said alert device is actuated when said ignition sensor senses that the vehicle ignition is OFF;
wherein said collected data including said motion sensor detecting motion inside the vehicle, said temperature sensor sensing a temperature inside the vehicle, and said sound sensor sensing sound inside the vehicle;
wherein said collected data is transmitted to said processor for processing said collected data and determining a presence of said unattended individual or pet inside the vehicle; and
further wherein said processor transmits an alert to said user device to notify the user to timely rescue said unattended individual or pet inside the vehicle when one or more of said collected data is outside of a threshold for said collected data.

2. The alert system for detecting unattended individuals or pets inside a vehicle of claim 1, wherein said alert is transmitted after said timer exceeds a threshold timer value.

3. The alert system for detecting unattended individuals or pets inside a vehicle of claim 1, wherein said alert is selected from one or more of the group consisting of an audio message, a textual message, an SMS, a video message, and a pop-up notification.

4. The alert system for detecting unattended individuals or pets inside a vehicle of claim 3, wherein said video message including a video image of said unattended individual or pet inside the vehicle.

5. The alert system for detecting unattended individuals or pets inside a vehicle of claim 1, wherein said communication network is selected from the group consisting of a cellular connection, a satellite service, a wireless local area network connection, and a Bluetooth network.

6. The alert system for detecting unattended individuals or pets inside a vehicle of claim 1, wherein said user is a driver of the vehicle.

7. The alert system for detecting unattended individuals or pets inside a vehicle of claim 1, wherein said power source is a rechargeable battery that supplies power to activate said alert device.

8. The alert system for detecting unattended individuals or pets inside a vehicle of claim 7, wherein said power source rechargeable by connecting said alert device to the vehicle with a charging cable.

9. The alert system for detecting unattended individuals or pets inside a vehicle of claim 1, wherein said portable housing in the form of a stuffed toy.

10. The alert system for detecting unattended individuals or pets inside a vehicle of claim 1, wherein said user is selected from the group consisting of a parent, a guardian, a grandparent, and a relative of said unattended individual or pet inside the vehicle.

11. An alert system for detecting unattended individuals or pets inside a vehicle, the alert system comprising:
an alert device;
a user device; and
a communication network;
wherein said alert device having a portable housing for placement inside a vehicle;
wherein said alert device having a power source, a processor, a transceiver, an ignition sensor, a timer, a camera, a motion sensor, a temperature sensor, a sound sensor, a speaker, and a comparator for collected data;
wherein said ignition sensor paired with a vehicle's electronic control unit for detecting status of an ignition system;
wherein said user device paired with said alert device with said communication network;
wherein a placement of said alert device including a position having a view of a rear seat of the vehicle to monitor an unattended individual or pet inside the vehicle;
wherein said user device is a mobile device carried by a user;
wherein said alert device transmits said collected data to said user device;
wherein said alert device is actuated when said ignition sensor senses that the vehicle ignition is OFF;
wherein said collected data including said motion sensor detecting motion inside the vehicle, said temperature sensor sensing a temperature inside the vehicle, and said sound sensor sensing sound inside the vehicle;
wherein said collected data is transmitted to said processor for processing said collected data and determining a presence of said unattended individual or pet inside the vehicle;
wherein said processor transmits an alert to said user device to notify the user to timely rescue said unattended individual or pet inside the vehicle when one or more of said collected data is outside of a threshold for said collected data; and
further wherein said speaker plays out a user message from the user transmitted through said user device.

12. The alert system for detecting unattended individuals or pets inside a vehicle of claim 11, wherein said user message is an alarm.

13. The alert system for detecting unattended individuals or pets inside a vehicle of claim 12, wherein said alert is transmitted after said timer exceeds a threshold timer value.

14. The alert system for detecting unattended individuals or pets inside a vehicle of claim 13, wherein said alert is selected from one or more of the group consisting of an audio message, a textual message, an SMS, a video message, and a pop-up notification.

15. The alert system for detecting unattended individuals or pets inside a vehicle of claim 14, wherein said video message including a video image of said unattended individual or pet inside the vehicle.

16. The alert system for detecting unattended individuals or pets inside a vehicle of claim 15, wherein said communication network is selected from the group consisting of a cellular connection, a satellite service, a wireless local area network connection, and a Bluetooth network.

17. The alert system for detecting unattended individuals or pets inside a vehicle of claim 16, wherein said user is a driver of the vehicle.

18. The alert system for detecting unattended individuals or pets inside a vehicle of claim 17, wherein said power source is a rechargeable battery that supplies power to activate said alert device.

19. The alert system for detecting unattended individuals or pets inside a vehicle of claim 18, wherein said power source rechargeable by connecting said alert device to the vehicle with a charging cable.

20. An alert system for detecting unattended individuals or pets inside a vehicle, the alert system comprising:
an alert device;
a user device; and
a communication network;
wherein said alert device having a portable housing for placement inside a vehicle;
wherein said alert device having a power source, a processor, a transceiver, an ignition sensor, a camera, a motion sensor, a temperature sensor, and a sound sensor for capturing collected data;
wherein said ignition sensor paired with a vehicle's electronic control unit for detecting status of an ignition system;
wherein said user device paired with said alert device with said communication network;
wherein said user device is a mobile device carried by a user;
wherein said alert device transmits said collected data to said user device;
wherein said alert device is actuated when said ignition sensor senses that the vehicle ignition is OFF;
wherein said collected data including said motion sensor detecting motion inside the vehicle, said temperature sensor sensing a temperature inside the vehicle, and said sound sensor sensing sound inside the vehicle;
wherein said collected data is transmitted to said processor for processing said collected data and determining a presence of said unattended individual or pet inside the vehicle; and
further wherein said processor transmits an alert to said user device to notify the user of said unattended individual or pet inside the vehicle when one or more of said collected data is captured.
